(19) United States
(12) Patent Application Publication
(10) Pub. No.: US 2025/0391118 A1
(43) Pub. Date: Dec. 25, 2025

(54) SYSTEM AND METHOD FOR QUALITY-AWARE ADAPTATION OF VIRTUAL REALITY BITSTREAM USING METADATA

(71) Applicant: VINUNIVERSITY, Hanoi (VN)

(72) Inventor: Nam Ngoc Pham, Hanoi (VN)

(73) Assignee: VINUNIVERSITY, Hanoi (VN)

(21) Appl. No.: 18/810,565

(22) Filed: Aug. 21, 2024

(30) Foreign Application Priority Data
Jun. 19, 2024 (VN) 1-2024-04514

(51) Int. Cl. G06T 19/00

(52) U.S. Cl. CPC G06T 19/00

(57) ABSTRACT

The invention relates to a system for adapting a Virtual Reality (VR) bitstream, comprising a metadata engine (101), a video client (104), a user feedback module (105), a decision engine (102), and an adaptation engine (103). The metadata engine (101) processes the VR bitstream, generating quality-related metadata for the decision engine (102). The adaptation engine (103) then modifies the VR bitstream based on instructions from the decision engine (102), producing an adapted bitstream for decoding and display by the VR video client (104). The user feedback module (105) collects real-time data from the video client (104), including view direction, lost frames, and current bandwidth. The decision engine (102) uses this information, along with metadata from the metadata engine (101), to determine which parts of the VR bitstream to remove. The invention also encompasses a method for adapting the VR bitstream based on this system.

### FIELD OF THE INVENTION

The present invention relates to a system and method for quality-aware adaptation of virtual reality bitstream using metadata. In particular, the present invention relates to a system and method to convey quality information within a VR video bitstream and to employ that information to enable adaptive VR video communication.

### BACKGROUND OF THE INVENTION

Due to huge bandwidth demand and the heterogeneity of communication networks, adaptivity has become an important feature of modern Virtual Reality (VR) video communications. Modern video bitstream is developed to create a wide variety of bitrates with high compression efficiency. An original VR bitstream should be easily truncated in different manners to meet various characteristics and variations of devices and connections. The scalability is possible thanks to the use of spatial tiling, where a video frame is divided into a number of rectangles, each can be considered as a video component.

In practice, a VR bitstream is divided into NAL (Network Abstraction Layer) units (NU), facilitating the delivery (including adaptation) of video content over packet-switching networks. Moreover, each component of a VR video is treated as a video substream, consisting of its own NAL units. From a VR bitstream, a view can be extracted using NAL units of appropriate streams or substreams, which cover the Field of View (FoV) being watched by the user. The information of scalability of a bitstream is crucial for any participant in a content delivery path to modify the bitstream effectively and efficiently.

In the present invention, the inventors propose a method and system architecture for quality-aware adaptation of VR bitstream using metadata to convey the quality information inside a scalable bitstream, so as providing sufficient to describe the scalability information of different kinds of bitstream.

Scalable video coding (SVC) is an approach to encode video format for applications of multimedia communication. SVC format is appropriate to create a wide variety of bitrates with high compression efficiency.

An original bitstream can be easily truncated in different manners to meet various characteristics and variations of devices and connections. Scalability is possible in three dimensions: spatial, temporal, and SNR. In VR video, the spatial dimension is divided into spatial tiles, each is a rectangular element video (hereafter called element video).

As a scalable bitstream can be adapted in different manners, there is an important demand for approaches which can appropriately guide the adaptation given some constraints (e.g., bitrate, display size). It is a fact that existing adaptation approaches are based on some criteria which are directly or indirectly related to the quality perceived by users when consuming the adapted contents.

To facilitate such adaptation, many studies have investigated the ways to convey the metadata about content quality associated with different adaptation operations. It should be noted that quality metadata is often available at encoding time or can be computed by some offline process.

In current video coding standards, the only information indirectly related to quality-aware adaptation is NU prioritization, which is based on the priority_id element of NAL unit header. The basic rule is that NAL units will be discarded in the decreasing order of priority_id until the resource (e.g., bitrate) constraint is met. All NU's having the same priority_id value is said to belong to one “priority layer”. Usually, priority_id's are assigned in an intelligent way so that an adapted bitstream (i.e., after discarding) has the best possible quality at that constraint.

However, it is well-known that a certain priority_id assignment of a bitstream is specific for only one adaptation strategy (sometimes called adaptation path). The priority_id in fact cannot represent the actual quality values which are needed for optimal quality adaptation.

### REFERENCES

1. Robert Skupin, Yago Sanchez, Y-K. Wang, Miska M. Hannuksela, J. Boyce, and Mathias Wien. “Standardization status of 360-degree video coding and delivery.” In 2017 IEEE Visual Communications and Image Processing (VCIP), pp. 1-4. IEEE, 2017.
2. Minh Nguyen, Hadi Amirpour, Christian Timmerer, and Hermann Hellwagner. “Scalable high efficiency video coding-based HTTP adaptive streaming over QUIC.” In Proceedings of the Workshop on the Evolution, Performance, and Interoperability of QUIC, pp. 28-34. 2020.
3. W3C Working Draft: “Scalable Video Coding (SVC) Extension for WebRTC”, February 2024, https://www.w3.org/TR/webrtc-svc/4.
4. Bross, Benjamin, Ye-Kui Wang, Yan Ye, Shan Liu, Jianle Chen, Gary J. Sullivan, and Jens-Rainer Ohm. “Overview of the versatile video coding (VVC) standard and its applications.” IEEE Transactions on Circuits and Systems for Video Technology 31, no. 10 (2021): 3736-3764.
5. Rickard Sjoberg, Ying Chen, Akira Fujibayashi, Miska M. Hannuksela, Jonatan Samuelsson, Thiow Keng Tan, Ye-Kui Wang, and Stephan Wenger. “Overview of HEVC high-level syntax and reference picture management.” IEEE transactions on Circuits and Systems for Video Technology 22, no. 12 (2012): 1858-1870.
6. “Extensible Markup Language (XML) 1.0 (Fifth Edition)”. World Wide Web Consortium. 26

### SUMMARY OF THE INVENTION

The present invention provides a system and method that uses metadata to describe the quality information inside a scalable VR bitstream, which enables flexible adaptation of that bitstream.

In the first aspect, the invention provides a system to adapt Virtual Reality (VR) bitstream, comprising at least one metadata engine (101); at least one video client (104); at least one user feedback module (105); at least one decision engine (102); and at least one adaptation engine (103)

wherein:
the metadata engine (101) takes as input a VR bitstream and generates the metadata to describe the quality information of the bitstream and provides the metadata to the decision engine (102);
the adaptation engine (103) receives the input VR bitstream and modifies it according to the instructions from the decision engine (102);
the output of the adaptation engine (103) is an adapted bitstream, which is delivered to the VR video client (104) to decode and display;
the user feedback module (105) gets current information of the video client (104), comprising current view direction, lost frames, current bandwidth, and the same situation;
the decision engine (102) receives information from the metadata engine (101) as well as the user feedback module (105) and decides the parts to be removed from the VR bitstream.

In the second aspect, the invention provides a method for adapting Virtual Reality (VR) bitstream, comprising:
arrange a system comprising at least one metadata engine (101); at least one video client (104); at least one user feedback module (105); at least one decision engine (102); and at least one adaptation engine (103);
using the metadata engine (101) to takes as input a VR bitstream and generates the metadata to describe the quality information of the bitstream and provides the metadata to the decision engine (102);
receiving the input VR bitstream by the adaptation engine (103) and modifies it according to the instructions from the decision engine (102);
delivering the output of the adaptation engine (103) which is an adapted bitstream to the VR video client (104) to decode and display;
using the user feedback module (105) to get current information of the video client (104), comprising current view direction, lost frames, current bandwidth, and the same situation;
receiving information from the metadata engine (101) as well as the user feedback module (105) by the decision engine (102) and decides the parts to be removed from the VR bitstream.

In a preferred embodiment of the invention, the bitstream may contain multiple element video sub streams for spatial scalability.

In a preferred embodiment of the invention, each element video's scalability can be further supported in multiple dimensions by other video standards.

In a preferred embodiment of the invention, the metadata engine (101) provides the metadata for each element video and its scalable dimensions.

In another preferred embodiment of the invention, the metadata can be represented by a Supplemental Enhancement Information (SEI) message in Network Abstraction Layer (NAL) units or other types of metadata such as XML.

In another preferred embodiment of the invention, the quality value in metadata can be of any metrics or any derivation from them.

In another preferred embodiment of the invention, the decision engine (102) and the adaptation engine (103) have flexibility in their locations, comprising at the sender side, receiver side, or in an intermediate node on the content delivery path.

In another preferred embodiment of the invention, parameters of user preference are used to constitute the constraints of decision engine (102).

In another preferred embodiment of the invention, any parameters input to decision engine (102) can be changed on the fly.

In another preferred embodiment of the invention, the adaptation engine (103) discards video data of multiple element videos simultaneously.

In another preferred embodiment of the invention, the instructions from decision engine (102) to adaptation engine (103) can be the priority_id values in the NAL unit headers.

In another preferred embodiment of the invention, the instructions from decision engine (102) to adaptation engine (103) can be truncated or discarded bitrates.

In another preferred embodiment of the invention, the input VR bitstream may have any configurations, any ratio of spatial scalability, any frame rate for a given spatial layer.

In another preferred embodiment of the invention, the metadata engine (101) can be used in both online and offline cases.

### BRIEF DESCRIPTION OF THE DRAWINGS

FIG. 1 is a block diagram illustrating the architecture of a VR video adaptive system.

FIG. 2 is a diagram illustrating the syntax of SEI message quality information.

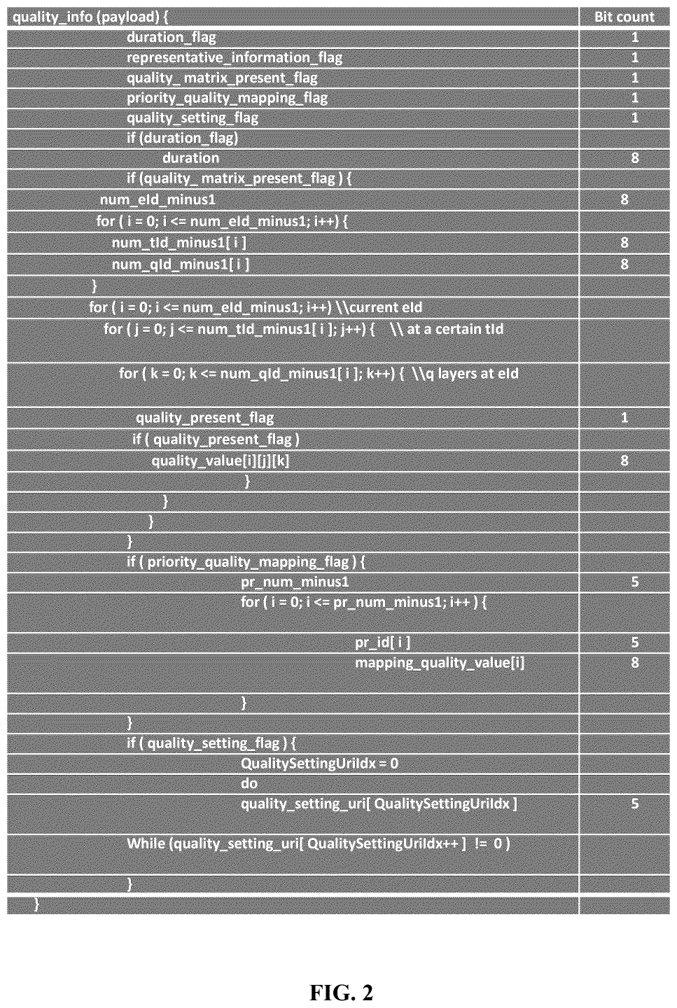

### DETAILED DESCRIPTION OF THE INVENTION

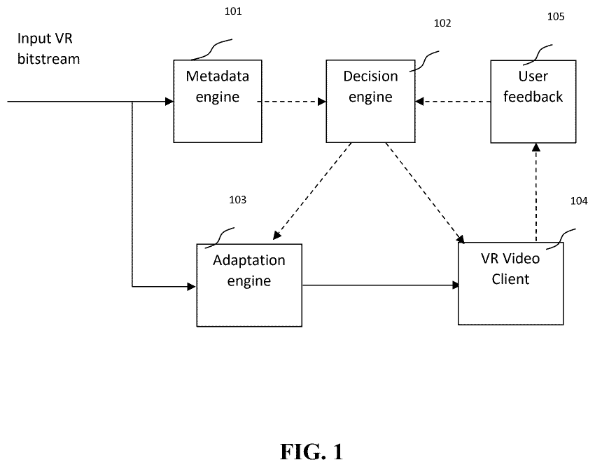

The architecture of the present invention is shown in FIG. 1. The Metadata engine (101) takes as input a VR bitstream and generates the metadata to describe the quality information of the bitstream and provides the metadata to the Decision engine (102). The Adaptation engine (103) receives the input VR bitstream and modifies it according to the instructions from the Decision engine (102). The output of the Adaptation engine is an adapted bitstream, which is delivered to the VR video client (104) to decode and display. The User feedback module (105) gets current information of the video client, such as current view direction, lost frames, current bandwidth, etc. The Decision engine (102) receives information from the Metadata engine (101) as well as the User feedback (105) and decides the parts to be removed from the VR bitstream.

### Usage Scenarios

The invention describes some typical adaptation scenarios where the quality information is useful. In practice, this quality information can be used in a wide variety of cases, such as single bitstream adaptation, multiple stream adaptation, and admission control for large-scale systems.

In the most straightforward scenario, when the quality information is available, an adaptation engine can easily adapt a single bitstream by searching for the combination of operations in three dimensions which meets the given constraints and, at the same time, results in the best quality for the user.

Further, when adapting multiple bitstreams, the quality information can be used to build the so-called utility functions, which are used in allocating resources (e.g., bandwidth) to the bistreams so as the overall utility (quality) of all users is maximized.

In a similar manner, utility functions can be used for admission control. This is a high-level process which decides whether requests for new sessions (thus new bitstreams) should be admitted or not.

### Solution of Quality Information in Scalable Bitstream

In video coding standards, metadata or information used for video manipulation is called Supplemental Enhancement Information (SEI) message. SEI messages are inserted into a bitstream and then later used by a machine (e.g., an adaptation engine, an intermediate node, or a decoder) to process the bitstream.

For adaptation purposes, the description of quality information of a VR bitstream will be designed to have the following features:
Quality value for each combination of adaptation operations in the three dimensions. As the discarding operation in each dimension is discrete, the number of all combinations will not be large.
A mapping of each priority layer to a quality value. By this way, we can obtain the “utility function” which corresponds to the accumulation of priority layers in a bitstream.
Support for content variations in time axis. That means, the description will consist of quality information which is specific for each video temporal segment.
Representative quality information for the whole bitstream or a part of bitstream which covers more than one temporal segment. This representative quality information can be used to quickly obtain the utility function of the bitstream which will be used in admission control.

The metadata of quality information for VR bitstream is represented in the form of the so-called quality information SEI (QSEI) message (given in the Annex). The key elements of this SEI message are as follows. It should be noted that the metadata presented can be provided in any other format such as XML.
duration_flag: If this flag is equal to 1, the information in this message will be valid for all NU's from the position of this SEI message and lasts for a time interval represented by the duration element. When this flag is equal to 0, the information is valid for all NU's from the position of this SEI message and until the appearance of the next quality information SEI message (or the end of sequence).
representative_information_flag: this flag indicates whether the information in this message can be used as the representative information for the bitstream in case where multiple bitstreams are considered at the same time.
quality_matrix_present_flag: this flag indicates whether the message includes quality information for different combinations of element_id, temporal_id, and quality_id (provided in matrix form).
priority_quality_mapping_flag: this flag indicates whether the message includes quality information for different priority layers.
quality_setting_flag: indicates whether the syntax element quality_setting_uri is present and the metric for quality value is known.
duration: describes the length of the current sequence.
num_eld_minus1: this value plus 1 specifies the number of element video substreams which will be described by this SEI message.
num_tId_minus1[i]: plus 1 specifies the number of temporal layers corresponding to the element video with element_id equal to i.
num_qId_minus1[i]: plus 1 specifies the number of quality layers corresponding to the element video with element_id equal to i.
quality_present_flag: this flag indicates whether the quality information exist
quality_value[i][j][k]: specifies the value of quality for the combination of element_id equal to i, temporal_id equal to j, and quality_id equal to k.
pr_num_minus1: plus 1 specifies the number of priority layers
pr_id[i]: specifies a priority layer
mapping_quality_value[i]: specifies the quality corresponding to the priority layer identified by pr_id[i].
quality_setting_uri[QualitySettingUriIdx] is the QualitySettingUriIdx-th byte of a null-terminated string encoded in UTF-8 characters, specifying the universal resource identifier (URI) of the description of the quality metric.

Note that, when the quality_present_flag is equal to 0, the corresponding quality value can still be obtained by interpolating the neighbor quality values. This flag would help to skip the unnecessary or unavailable quality values for certain operations, and thus reducing the complexity of the message.

### Advantageous Effects of the Invention

The system and method provided by the present invention help to flexibly adapt the VR video bitstream in multi-dimensionality and deliver the most optimal VR video quality to users under different constraints on the user's device processing capability, the network bandwidth to the user, and the user's preferences.

In addition, in the case of multiple bitstreams adaptation, or access control for large-scale systems, the quality information proposed in the present invention allows the construction of utility functions for optimal problems that fully reflect the quality aspects and user preferences thereby allowing for more optimal use of system resources.

What is claimed is:

1. A system to adapt Virtual Reality (VR) bitstream, comprising at least one metadata engine (101); at least one video client (104); at least one user feedback module (105); at least one decision engine (102); and at least one adaptation engine (103)
wherein:
the metadata engine (101) takes as input a VR bitstream and generates the metadata to describe the quality information of the bitstream and provides the metadata to the decision engine (102);
the adaptation engine (103) receives the input VR bitstream and modifies it according to the instructions from the decision engine (102);
the output of the adaptation engine (103) is an adapted bitstream, which is delivered to the VR video client (104) to decode and display;
the user feedback module (105) gets current information of the video client (104), comprising current view direction, lost frames, current bandwidth, and the same situation;
the decision engine (102) receives information from the metadata engine (101) as well as the user feedback module (105) and decides the parts to be removed from the VR bitstream.

2. The system according to claim 1, wherein the bitstream may contain multiple element video substreams for spatial scalability.

3. The system according to claim 1, wherein each element video's scalability can be further supported in multiple dimensions by other video standards.

4. The system according to claim 1, wherein the metadata engine (101) provides the metadata for each element video and its scalable dimensions.

5. The system according to claim 1, wherein the metadata can be represented by a Supplemental Enhancement Information (SEI) message in Network Abstraction Layer (NAL) units or other types of metadata such as XML.

6. The system according to claim 1, wherein the quality value in metadata can be of any metrics or any derivation from them.

7. The system according to claim 1, wherein the decision engine (102) and the adaptation engine (103) have flexibility in their locations, comprising at the sender side, receiver side, or in an intermediate node on the content delivery path.

8. The system according to claim 1, wherein parameters of user preference are used to constitute the constraints of decision engine (102).

9. The system according to claim 1, wherein any parameters input to decision engine (102) can be changed on the fly.

10. The system according to claim 1, wherein the adaptation engine (103) discards video data of multiple element videos simultaneously.

11. The system according to claim 1, wherein the instructions from decision engine (102) to adaptation engine (103) can be the priority_id values in the NAL unit headers.

12. The system according to claim 1, wherein the instructions from decision engine (102) to adaptation engine (103) can be truncated or discarded bitrates.

13. The system according to claim 1, wherein the input VR bitstream may have any configurations, any ratio of spatial scalability, any frame rate for a given spatial layer.

14. The system according to claim 1, wherein the metadata engine (101) can be used in both online and offline cases.

15. Method for adapting Virtual Reality (VR) bitstream, comprising:
arrange a system comprising at least one metadata engine (101); at least one video client (104); at least one user feedback module (105); at least one decision engine (102); and at least one adaptation engine (103);
using the metadata engine (101) to takes as input a VR bitstream and generates the metadata to describe the quality information of the bitstream and provides the metadata to the decision engine (102);
receiving the input VR bitstream by the adaptation engine (103) and modifies it according to the instructions from the decision engine (102);
delivering the output of the adaptation engine (103) which is an adapted bitstream to the VR video client (104) to decode and display;
using the user feedback module (105) to get current information of the video client (104), comprising current view direction, lost frames, current bandwidth, and the same situation;
receiving information from the metadata engine (101) as well as the user feedback module (105) by the decision engine (102) and decides the parts to be removed from the VR bitstream.

16. The method according to claim 15, wherein the bitstream may contain multiple element video substreams for spatial scalability.

17. The method according to claim 15, wherein each element video's scalability can be further supported in multiple dimensions by other video standards.

18. The method according to claim 15, wherein the metadata engine (101) provides the metadata for each element video and its scalable dimensions.

19. The method according to claim 15, wherein the metadata can be represented by a Supplemental Enhancement Information (SEI) message in Network Abstraction Layer (NAL) units or other types of metadata such as XML.

20. The method according to claim 15, wherein the quality value in metadata can be of any metrics or any derivation from them.

21. The method according to claim 15, wherein the decision engine (102) and the adaptation engine (103) have flexibility in their locations, comprising at the sender side, receiver side, or in an intermediate node on the content delivery path.

22. The method according to claim 15, wherein parameters of user preference are used to constitute the constraints of decision engine (102).

23. The method according to claim 15, wherein any parameters input to decision engine (102) can be changed on the fly.

24. The method according to claim 15, wherein the adaptation engine (103) discards video data of multiple element videos simultaneously.

25. The method according to claim 15, wherein the instructions from decision engine (102) to adaptation engine (103) can be the priority_id values in the NAL unit headers.

26. The method according to claim 15, wherein the instructions from decision engine (102) to adaptation engine (103) can be truncated or discarded bitrates.

27. The method according to claim 15, wherein the input VR bitstream may have any configurations, any ratio of spatial scalability, any frame rate for a given spatial layer.

28. The method according to claim 15, wherein the metadata engine (101) can be used in both online and offline cases.
